(19) United States
(12) Patent Application Publication
(10) Pub. No.: US 2015/0062715 A1
(43) Pub. Date: Mar. 5, 2015

(54) OPTICAL DEVICE AND IMAGE DISPLAY APPARATUS

(71) Applicant: Seiko Epson Corporation, Tokyo (JP)

(72) Inventors: Fumika Yamada, Matsumoto-shi (JP); Masatoshi Yonekubo, Hara-mura (JP); Osamu Yokoyama, Shiojiri-shi (JP)

(21) Appl. No.: 14/468,476

(22) Filed: Aug. 26, 2014

(30) Foreign Application Priority Data
Aug. 30, 2013 (JP) 2013-179161

(51) Int. Cl. G02B 27/01; G02B 5/18

(52) U.S. Cl. CPC G02B 27/0172; G02B 5/18; G02B 2027/0174; G02B 2027/0178
USPC 359/630

(57) ABSTRACT

A first diffraction optical element is disposed on a light incident surface of a light guide, a second diffraction optical element is disposed on a light emitting surface of the light guide, and a reflection layer is disposed on an end surface of the light guide. A diffraction grating of the first diffraction optical element and a diffraction grating of the second diffraction optical element has an inclined portion respectively. The inclined portion of the first diffraction optical element and the inclined portion of the second diffraction optical element are inclined in same direction.

### BACKGROUND

1. Technical Field

The present invention relates to an optical device which uses a light guide and a diffraction optical element, and an image display apparatus which is provided with the optical device.

2. Related Art

In recent years, a head mount display which uses a light guide, guides light to the front of eyes of an observer, and displays an image from an image display apparatus, has been commercialized as an image projecting device. Furthermore, development to make the head mount display have a smaller size, a wider angle of view, and higher efficiency, has been performed. In particular, a diffraction optical element attracts attention as one of the elements for making the light be incident on the inside of the light guide and be emitted. Since the diffraction optical element can control a travelling direction of the light by using a diffraction phenomenon, the diffraction optical element can be obtained smaller and have higher operation flexibility of the light than an optical element which uses reflection or refraction.

Among the diffraction optical elements, in particular, a volume hologram can perform diffraction at comparatively high efficiency. However, in a case of the volume hologram, since a wavelength, angle or the like of diffracted light is determined according to a Bragg condition, the angle and the wavelength of the diffracted light is largely influenced by an incident angle. For this reason, when the volume hologram is used in the image display apparatus, such as the head mount display, there is a case where influence on the angle (size) of view and color irregularity of a display image becomes greater. Here, in the related art, an image display apparatus which adjusts the incident angle of the volume hologram is suggested (for examples, refer to JP-A-2007-94175 and JP-A-2009-133998).

The image display apparatus disclosed in JPA-2007-94175 suppresses a wavelength change of the diffracted light with respect to an incident angle change caused by the Bragg condition by partially changing an inclined angle of an interference fringe, and reduces generation of the color irregularity on the display image.

Meanwhile, in the image display apparatus disclosed in JP-A-2009-133998, by inclining an optical axis of which light is incident on the diffraction optical element, a wavelength selectivity caused by the Bragg condition is mitigated, a wavelength range in which diffraction can be performed is controlled, and problems, such as the color irregularity, can be solved.

However, as the image display apparatus disclosed in JP-A-2007-94175 shows, there is a problem in that it is difficult to partially change the inclined angle of the interference fringe in manufacturing, and practicality is lacking. Meanwhile, as the image display apparatus disclosed in JP-A-2009-133998 shows, when the incident angle is inclined in a direction in which the wavelength selectivity is mitigated, since the direction becomes a direction in which the angles of the incident light and the emitted light are expanded with respect to the light guide, under a usage mode of the head mount display which is mounted on a head of the observer, there is a problem in that a positional relationship between the right/left light guides and an image forming apparatus does not match a shape of the head of the observer, a fitting property with respect to the head of the observer deteriorates, and an uncomfortable feeling is created when using the head mount display.

### SUMMARY

An advantage of some aspects of the invention is to provide an optical device having a smaller size, a higher angle of view, and higher efficiency, and an image display apparatus provided with the optical device without difficulty in manufacturing.

The optical device according to a first aspect of the invention includes: a light guide; a first diffraction optical element which makes light incident on the light guide; a second diffraction optical element which emits the light from the light guide; and a reflection layer provided on a second surface of the light guide which intersects with a first surface of the light guide provided with the first diffraction optical element and the second diffraction optical element. Protruded portions which constitute the first diffraction optical element and the second optical element are respectively inclined in a first direction which is the same as a normal line direction of the first surface.

According to the first aspect of the optical device of the invention, the first diffraction optical element is disposed on the first surface, image light is incident on the inside of the light guide, and the image light is reflected to a surface of an emission side of the light guide by the reflection layer provided on the second surface which intersects with the first surface. The second diffraction optical element is disposed on the first surface, and the reflected light is diffracted to the outside of the light guide. In addition, the protruded portions which constitute the first diffraction optical element and the second diffraction optical element are respectively inclined in the first direction which is the same as the normal line direction of the first surface. Therefore, it is possible to increase diffraction efficiency. In addition, since an optical axis of the incident light and an optical axis of the emitted light are parallel, it is possible to match a positional relationship between the right/left light guides and a light source to a head shape or a position of eyes of the observer. Furthermore, when the aspect of the optical device according to the invention is employed in a head mount display which is mounted on a head of the observer, a fitting property with respect to the face of the observer can be improved.

According to the first aspect of the optical device of the invention, the first diffraction optical element and the second diffraction optical element may respectively be surface relief type holograms provided with an uneven structure on one surface. As either the first diffraction optical element or the second diffraction optical element is, for example, an inclined surface relief type hologram provided with an uneven structure inclined with respect to the surface, it is possible to further strengthen a plus first-order diffracted light, and to obtain an effect of further reducing generation of noise light during transmission.

According to the first aspect of the optical device of the invention, the first diffraction optical element and the second diffraction optical element are respectively diffraction optical elements in a shape of a blazed grating provided with protruded portions in a serrated shape on one surface. The inclined surfaces of the protruded portions in a serrated shape may be respectively inclined in the first direction. As either the first diffraction optical element or the second diffraction optical element is a diffraction element provided with the blazed grating on the surface, it is possible to enhance the first-order diffraction efficiency, and to improve transmission efficiency to the light guide.

The optical device according to a second aspect of the invention includes: a light guide; a first diffraction optical element which makes light incident on the light guide; a second diffraction optical element which emits the light from the light guide; and a reflection layer provided on a second surface of the light guide which intersects with a first surface of the light guide provided with the first diffraction optical element or the second diffraction optical element. A first portion and a second portion which respectively constitute the first diffraction optical element and the second diffraction optical element and have different refractive indexes from each other, are respectively inclined in the first direction which is the same as the normal line direction of the first surface.

According to the second aspect of the optical device of the invention, the first diffraction optical element is disposed on the first surface, an image light is incident on the inside of the light guide, and the image light is reflected to a surface of an emission side of the light guide by the reflection layer provided on the second surface which intersects with the first surface. The second diffraction optical element is disposed on the first surface, and the reflected light is diffracted to the outside of the light guide. The first portion and the second portion which respectively constitute the first diffraction optical element and the second diffraction optical element and have different refractive indexes from each other, are respectively inclined in the first direction which is the same as the normal line direction of the first surface. Therefore, it is possible to increase the diffraction efficiency. In addition, since the optical axis of the incident light and the optical axis of the emitted light are parallel, it is possible to match the positional relationship between the right/left light guides and the light source to the face shape or the position of the eyes of the observer. Furthermore, when the aspect of the optical device according to the invention is employed in a head mount display which is mounted on the head of the observer, the fitting property with respect to the face of the observer can be improved.

According to the second aspect of the optical device of the invention, the first diffraction optical element and the second diffraction optical element may be transmission type volume holograms. As the first diffraction optical element and the second diffraction optical element are transmission type volume holograms, it is possible to enhance first-order diffraction efficiency, and to improve the transmission efficiency to the light guide.

According to the first and the second aspects of the optical device of the invention, the first diffraction optical element and the second diffraction optical element are transmission type diffraction optical elements, and are provided on the same surface of the light guide. In a cross-sectional view of the light guide including both the first diffraction optical element and the second diffraction optical element, it is preferable that the first direction be a direction which is inclined in a direction from the second diffraction optical element toward the first diffraction optical element with respect to the normal line direction of the first surface. In this case, it is possible to enhance the diffraction efficiency. In addition, since the optical axis of the incident light and the optical axis of the emitted light are parallel, it is possible to match the positional relationship between the right/left light guides and the light source to the face shape or the position of the eyes of the observer. Furthermore, when the aspect of the optical device according to the invention is employed in the head mount display which is mounted on the head of the observer, the fitting property with respect to the face of the observer can be improved.

The optical device according to a third aspect of the invention includes: a light guide; a first diffraction optical element which diffracts light incident to the light guide; a second diffraction optical element which diffracts and emits the light guided to the light guide; and a reflection layer provided on a second surface of the light guide which intersects with a first surface of the light guide provided with the first diffraction optical element or the second diffraction optical element. A first portion and a second portion which constitute the first diffraction optical element and the second diffraction optical element and have different refractive indexes from each other, are respectively inclined in the first direction which is the same as the normal line direction of the first surface.

According to the third aspect of the optical device of the invention, the first diffraction optical element is disposed on the first surface, an image light incident on the light guide is diffracted to the inside the light guide, and the image light is reflected to a surface of an emission side of the light guide by the reflection layer provided on the second surface which intersects with the first surface. The second diffraction optical element is disposed on the first surface, and the reflected light is diffracted to the outside of the light guide. In addition, the first portion and the second portion which constitute the first diffraction optical element and the second diffraction optical element and have different refractive indexes from each other, are respectively inclined in the first direction which is the same as the normal line direction of the first surface. Therefore, it is possible to increase the diffraction efficiency. In addition, since the optical axis of the incident light and the optical axis of the emitted light are parallel, it is possible to match the positional relationship between the right/left light guides and the light source to the face shape or the position of the eyes of the observer. Furthermore, when the aspect of the optical device according to the invention is employed in a head mount display which is mounted on the head of the observer, the fitting property with respect to the face of the observer can be improved.

According to the third aspect of the optical device of the invention, the first diffraction optical element and the second diffraction optical element are reflection type diffraction optical elements, and are provided on the same surface of the light guide. In a cross-sectional view of the light guide including both the first diffraction optical element and the second diffraction optical element, it is preferable that the first direction be a direction which is inclined in a direction from the second diffraction optical element toward the first diffraction optical element with respect to the normal line direction of the first surface. In this case, it is possible to enhance the diffraction efficiency. In addition, since the optical axis of the incident light and the optical axis of the emitted light are parallel, it is possible to match the positional relationship between the right/left light guides and the light source to the head shape or the position of the eyes of the observer. Furthermore, when the aspect of the optical device according to the invention is employed in the face mount display which is mounted on the head of the observer, the fitting property with respect to the face of the observer can be improved.

The optical device according to a fourth aspect of the invention includes: a first light guide; a first diffraction optical element which makes light incident on the first light guide; a second diffraction optical element which emits the light from the first light guide; a first reflection layer provided on a second surface of the light guide which intersects with a first surface of the light guide provided with the first diffraction optical element or the second diffraction optical element; a second light guide; a third diffraction optical element which makes light incident on the second light guide; a fourth diffraction optical element which emits the light from the second light guide; and a second reflection layer provided on a fourth surface of the light guide which intersects with a third surface of the light guide provided with the second diffraction optical element or the third diffraction optical element. A first portion and a second portion which constitute the first diffraction optical element and the second diffraction optical element and have different refractive indexes from each other, are respectively inclined in the first direction which is the same as the normal line direction of the first surface. A third portion and a fourth portion which constitute the third diffraction optical element and the fourth diffraction optical element and have different refractive indexes from each other, are respectively inclined in the second direction which is the same as the normal line direction of the third surface.

The optical device according to a fifth aspect of the invention includes: a first light guide; a first diffraction optical element which diffracts light incident on the first light guide; a second diffraction optical element which diffracts and emits the light guided to the first light guide; a first reflection layer provided on a second surface of the light guide which intersects with a first surface of the light guide provided with the first diffraction optical element or the second diffraction optical element; a second light guide; a third diffraction optical element which diffracts light incident on the second light guide; a fourth diffraction optical element which diffracts and emits light guided to the second light guide; and a second reflection layer provided on a fourth surface of the light guide which intersects with a third surface of the light guide provided with the third diffraction optical element or the fourth diffraction optical element. A first portion and a second portion which constitute the first diffraction optical element and the second diffraction optical element and have different refractive indexes from each other, are respectively inclined in the first direction which is the same as the normal line direction of the first surface. A third portion and a fourth portion which constitute the third diffraction optical element and the fourth diffraction optical element and have different refractive indexes from each other, are respectively inclined in the second direction which is the same as the normal line direction of the third surface.

Next, an image display apparatus according to the invention is provided with the above-described optical device according to the invention and an image forming portion which generates the image light. The image display apparatus may include an image forming portion, such as a liquid crystal display, or a collimate optical system. The image display apparatus can be appropriate to a form in which the apparatus is mounted on the head of the observer, such as the head mount display.

In addition, in the above-described image display apparatus according to the invention, the “image forming portion” includes the image display apparatus, such as the liquid crystal display or a laser scanning type display, which allows the observer to recognize an image by scanning laser light that displays the image, and an optical system which collects and converts the image light emitted from the image display apparatus.

### BRIEF DESCRIPTION OF THE DRAWINGS

The invention will be described with reference to the accompanying drawings, wherein like numbers reference like elements.

FIG. 1 is a perspective view illustrating an example of an entire image of a head mount display according to a first embodiment.

FIG. 2 is a cross-sectional view of a main part illustrating an example of an internal structure and a wave guide of an optical system for a right eye of the head mount display according to the first embodiment.

FIG. 3 is a cross-sectional view of the main part illustrating an example of an internal structure and a wave guide of an optical system for a left eye of the head mount display according to the first embodiment.

FIG. 4 is a cross-sectional view of the main part illustrating an inclination of a diffraction grating in a first diffraction optical element.

FIG. 5 is a cross-sectional view of the main part illustrating an inclination of a diffraction grating in a second diffraction optical element.

FIG. 6 is a view illustrating light which is incident on the second diffraction optical element before reflection, and light which is incident on the second diffraction optical element after reflection.

FIG. 7 is a graph illustrating an example of a relationship between an incident angle and diffraction efficiency of the light which is incident on the second diffraction optical element before reflection and the light which is incident on the second diffraction optical element after reflection.

FIG. 8 is a view illustrating a difference of the diffraction efficiency of the light which is incident on the second diffraction optical element before reflection and the diffraction efficiency of the light which is incident on the second diffraction optical element after reflection.

FIG. 9 is a view illustrating an example of positions of each apparatus when the head mount display according to the first embodiment is mounted.

FIG. 10 is a view illustrating position of each apparatus when the head mount display in the related art is mounted.

FIG. 11 is a cross-sectional view of the main part illustrating an example of an internal structure and a wave guide of an optical system for a left eye of the head mount display according to a second embodiment.

FIG. 12 is a view illustrating a method of generating an interference fringe in a thin hologram and in a thick hologram.

FIG. 13 is a view illustrating an interference fringe of an amplitude hologram.

FIG. 14 is a view illustrating an interference fringe of a phase hologram.

FIG. 15 is a view illustrating an interference fringe of another phase hologram.

FIG. 16 is a graph illustrating diffraction efficiency with respect to a change of the incident angle of each RGB wavelength which is optimized with respect to incident light which has 0 degrees of an optical axis inclination and is incident on a transmission type volume hologram.

FIG. 17 is a graph illustrating diffraction efficiency with respect to a change of the incident angle of each RGB wavelength which is optimized with respect to incident light which has −20 degrees of the optical axis inclination and is incident on the transmission type volume hologram.

FIG. 18 is a view illustrating an example of positions of the wave guide inside the light guide and the image display apparatus when the image light which has −20 degrees of the optical axis inclination and is incident on a transmission type volume hologram is used.

FIG. 19 is a view illustrating an example of positions of the wave guide inside the light guide and the image display apparatus when the image light which has 0 degrees of the optical axis inclination and is incident on a transmission type volume hologram is used.

FIG. 20 is a cross-sectional view of the main part illustrating an example of an internal structure and a wave guide of an optical system for a left eye of the head mount display according to a third embodiment.

FIG. 21 is a view illustrating a relationship between a plus first-order light and a minus first-order light in a surface relief hologram in a rectangular shape without an inclination.

FIG. 22 is a view illustrating a relationship between the plus first-order light and the minus first-order light in an inclined surface relief hologram.

FIG. 23 is a cross-sectional view of the main part illustrating an example of an internal structure and a wave guide of an optical system for a left eye of the head mount display according to a fourth embodiment.

FIG. 24 is a cross-sectional view of the main part illustrating an example of an internal structure and a wave guide of an optical system for a left eye of the head mount display according to a fifth embodiment.

FIG. 25 is a cross-sectional view of the main part illustrating an example of an internal structure and a wave guide of an optical system for a left eye of the head mount display according to a modification example.

### DESCRIPTION OF EXEMPLARY EMBODIMENTS

Hereinafter, various embodiments according to the invention will be described with reference to the attached drawings. In the drawings, a ratio of dimensions of each portion is appropriately different from a real ratio. In addition, in the embodiments described below, a case where an optical device of the invention is employed in a head mount display which is an example of an image display apparatus that is mounted on a head of an observer is described as an example. However, the embodiment represents an aspect of the invention, and the invention is not limited thereto. The invention can be arbitrarily modified within a range of a technical idea of the invention.

### A: First Embodiment

### Entire Configuration of Head Mount Display

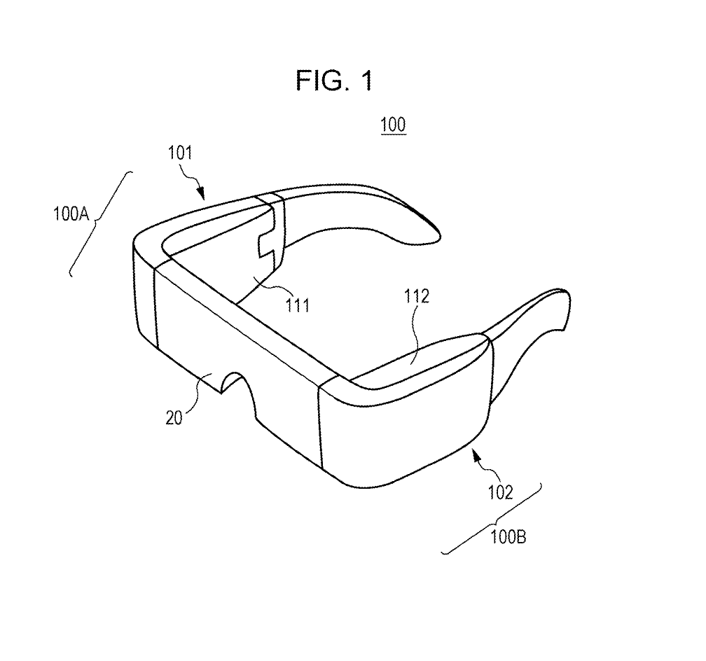

FIG. 1 is an example of a perspective view of an entire image of a head mount display 100 according to a first embodiment. As illustrated in FIG. 1, the head mount display 100 according to the embodiment is a head mount display which has an outer appearance of glasses. The head mount display 100 can allow the observer who has mounted the head mount display 100 to recognize the image light by a virtual image, and can allow the observer to observe an external image in a see-through manner.

In particular, the head mount display 100 includes a light guide 20, a pair of right and left temples 101 and 102 which supports the light guide 20, and a pair of image forming apparatuses 111 and 112 which is added to the temples 101 and 102. Here, in the drawing, a first image apparatus 100A which is a combination of a left side of the light guide 20 and the image forming apparatus 111 is a portion that forms a virtual image for a right eye and functions as the image display apparatus independently. In addition, in the drawing, a second display apparatus 100B which is a combination of a right side of the light guide 20 and the image forming apparatus 112 is a portion that forms a virtual image for a left eye and functions as the image display apparatus even independently.

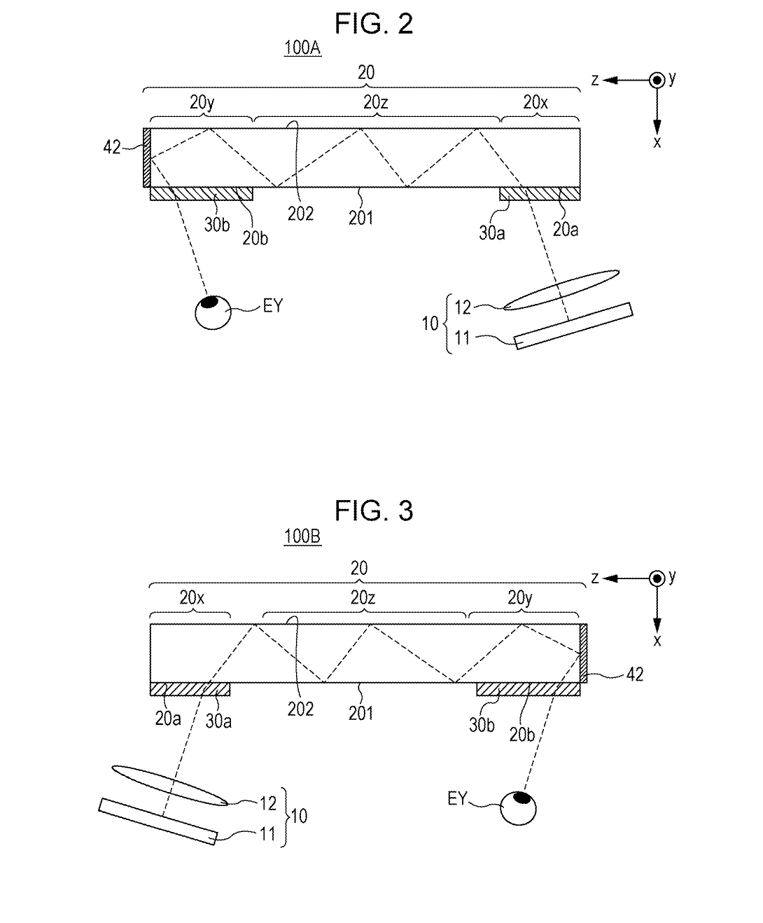

An internal structure and the light guide of the head mount display 100 will be described. FIG. 2 is a schematic cross-sectional view of the main part illustrating the internal structure and the light guide of the head mount display according to the embodiment. FIG. 2 is a cross-sectional view of a main part illustrating an example of an internal structure and the light guide of an optical system for the right eye, and FIG. 3 is a cross-sectional view of the main part illustrating an example of an internal structure and the light guide of an optical system for the left eye, according to the embodiment. As illustrated in FIGS. 2 and 3, each of first display apparatus 100A and the second display apparatus 100B include an image forming portion 10 and the light guide 20.

The image forming portion 10 includes an image display apparatus 11 and a projection optical system 12. Among these, in the embodiment, the image display apparatus 11 is a liquid crystal display device, generates light including 3 colors, such as red, green, and blue, from a light source, and emits the light to the projection optical system 12 by scattering the light from the light source to be a luminous flux of a rectangular cross section. Meanwhile, the projection optical system 12 is a collimating lens that converts the image light emitted from each point on the image display apparatus 11 to a luminous flux in a parallel state, and makes the light incident on the light guide 20. In particular, in the embodiment, in order to obtain a wide angle of view, the image forming portion 10 is disposed to be inclined with respect to the normal line direction which is orthogonal to a panel.

An overall outer appearance of the light guide 20 is formed by a flat plate-shaped member which extends parallel to an YZ plane in the drawing. The light guide 20 is a plate-shaped member formed of an optically transparent resin material or the like, and includes a first panel surface 201 disposed facing the image forming portion 10 and a second panel surface 202 facing the first panel surface 201. The image light is incident through a light incident surface 20a formed at an end portion of the first panel surface 201, and is guided to a light emitting surface 20b formed in the front of the eyes of the observer by the first panel surface 201 and the second panel surface 202.

Specifically, the light guide 20 includes the light incident surface 20a which is a light incident portion to which the image light is incorporated from the image forming portion 10 and the light emitting surface 20b which emits the image light toward an eye EY of the observer, on a flat surface of a rear side or an observer side facing the image forming portion 10 in parallel to the YZ plane. On the light incident surface 20a, a first diffraction optical element 30a which diffracts the incident light in an end surface direction of a temple 102 side near to an incident position is provided. On the light emitting surface 20b, a second diffraction optical element 30b which diffracts and transmits the image light emitted toward the outside from the light emitting surface 20b, and projects the image light to the eye EY of the observer as the virtual light is provided. In other words, the light guide 20 includes an incident portion 20x which is a portion between the light incident surface 20a and a surface facing the light incident surface 20a, an emitting portion 20y which is a portion between the light emitting surface 20b and a surface facing the light emitting surface 20b, and a light guide portion 20z which is a portion between the incident portion 20x and the emitting portion 20y.

In the embodiment, grating cycles of the first diffraction optical element 30a and the second diffraction optical element 30b are the same, and inclination directions of the grating are also the same. The light guide 20 has the first panel surface 201 and the second panel surface 202 which face each other and extend in parallel with respect to the YZ plane, entirely reflects the image light diffracted by the first diffraction optical element 30a in the incident side by the reflection layer 42 disposed at an end portion of a wave guide of the second diffraction optical element 30b, and guides the light to the front of the eyes of the observer. Specifically, the image light diffracted by the first diffraction optical element 30a, first of all, is incident on the second panel surface 202 and is entirely reflected. Then, the image light is incident on the first panel surface 201 and is entirely reflected. By repeating the operation described above hereinafter, the image light is guided to the reflection layer 42 provided in the other end (nose side of the observer) of the light guide 20. After the image light reflected in the reflection layer 42 is diffracted by the second diffraction optical element 30b of the light emitting surface 20b, the image light is emitted toward the eye EY.

In addition, without applying a reflection coating onto the first panel surface 201 and the second panel surface 202, outer light which is incident on both the panel surfaces 201 and 202 from the outside may pass through the light guide 20 at high transmittance. Accordingly, the light guide 20 can be a see-through type which can see through the external image.

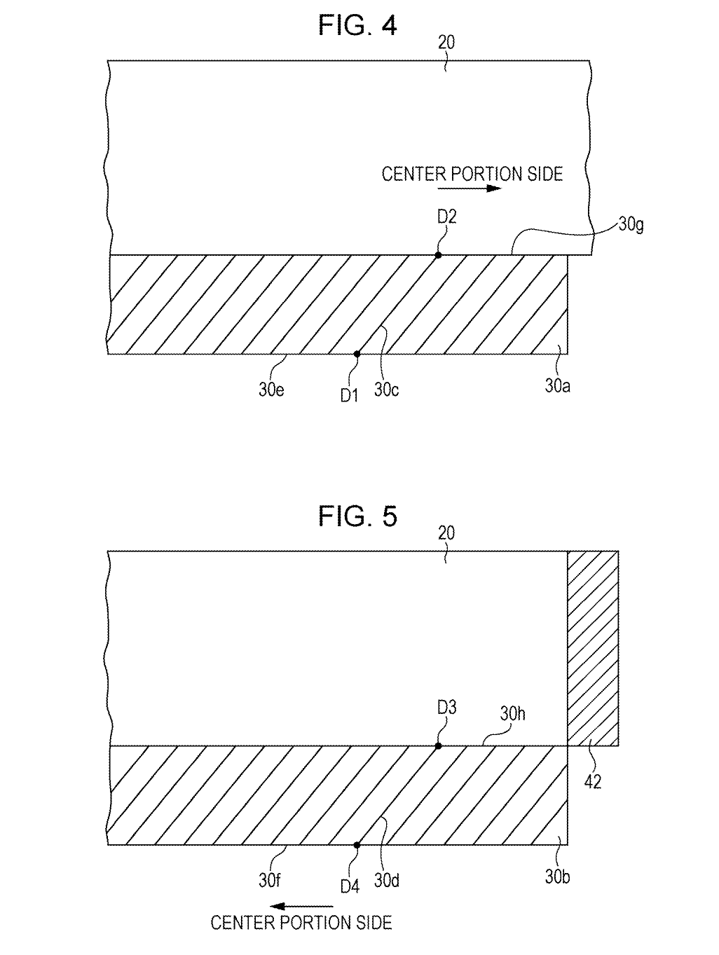

In the embodiment, as illustrated in FIG. 4, a diffraction grating 30c of the first diffraction optical element 30a is inclined so that a position D2 of the diffraction grating 30c on a contact surface 30g with the light guide 20 of the first diffraction optical element 30a is nearer to a center portion side of the light guide 20 rather than a position D1 of the diffraction grating 30c on the incident surface 30e of the first diffraction optical element 30a.

In addition, as illustrated in FIG. 5, a diffraction grating 30d of the second diffraction optical element 30b is inclined so that a position D4 of the diffraction grating 30d on an emitting surface 30f of the second diffraction optical element 30b is nearer to the center portion side of the light guide 20 rather than a position D3 of the diffraction grating 30d on a contact surface 30h with the light guide 20 of the second diffraction optical element 30b.

In this manner, the directions of inclination of the diffraction grating 30c of the first diffraction optical element 30a and the diffraction grating 30d of the second diffraction optical element 30b are the same, and the angles of inclination are also the same.

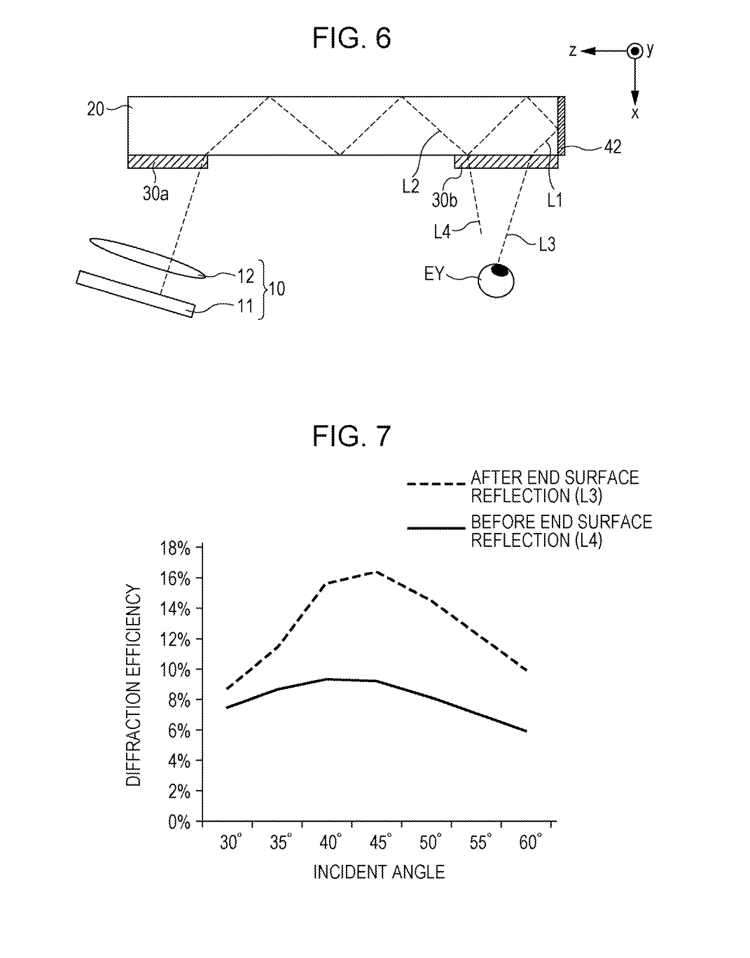

In a case where the first diffraction optical element 30a and the second diffraction optical element 30b are configured in this manner, as illustrated in FIG. 6, there are two types of the image light which is incident on the second diffraction optical element 30b, such as light L1 after the light is reflected by the reflection layer 42 on an end surface of the light guide 20 and light L2 before the light is reflected by the reflection layer 42. By the image lights L1 and L2, diffracted lights L3 and L4 which have different optical axis directions before and after the reflection are generated.

Diffraction efficiency of the diffracted lights L3 and L4 is illustrated in FIG. 7. As illustrated in FIG. 7, it is known that the diffraction efficiency of the diffracted light L3 which is reflected on the reflection layer 42 and diffracted in the second diffraction optical element 30b after the reflection is higher than that of the diffracted light L4 which is diffracted by the second diffraction optical element 30b before the reflection on the reflection layer 42.

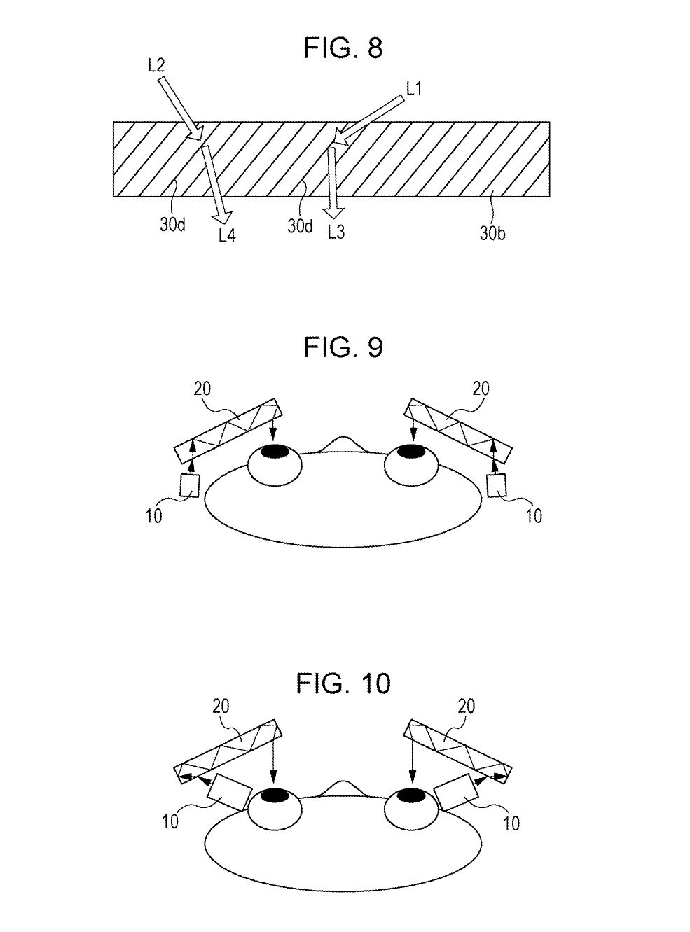

As illustrated in FIG. 8, since the diffraction grating 30d of the second diffraction optical element 30b in the embodiment has the inclination as described above, the light L2 before the reflection by the reflection layer 42 is incident on the diffraction grating 30d by an angle smaller than a critical angle, is refracted, and is extracted as the diffracted light L4. Meanwhile, the light L1 after the reflection by the reflection layer 42 is incident on the diffraction grating 30d at an angle equal to or greater than the critical angle and is extracted as the diffracted light L3 by Bragg reflection. In this manner, since a part of the light L2 before the reflection is blocked by the diffraction grating 30d, light intensity is reduced. However, since the light L1 after the reflection becomes the diffracted light L3 by the Bragg reflection, intensity of the light L1 is not reduced, and the diffraction efficiency of the light L1 is higher than that of the diffracted light L4.

As described above, the diffraction grating 30c of the first diffraction optical element 30a is inclined so that the position on the contact surface 30g with the light guide 20 is nearer to the center portion side of the light guide 20 rather than the position on the incident surface 30e of the first diffraction optical element 30a. The diffraction grating 30d of the second diffraction optical element 30b is inclined so that the position on the emitting surface 30f of the second diffraction optical element 30b is nearer to the center portion side of the light guide 20 rather than the position on the contact surface 30h with the light guide 20. Since an angle of inclination of the diffraction grating 30c of the first diffraction optical element 30a and an angle of inclination of the diffraction grating 30d of the second diffraction optical element 30b are set to be the same, it is possible to enhance the diffraction efficiency.

In addition, in the embodiment, the grating cycles of the diffraction grating 30c of the first diffraction optical element 30a and the diffraction grating 30d of the second diffraction optical element 30b are the same, and the directions of the inclination of the diffraction gratings 30c and 30d are the same directions in the incident side and in the emitting side. Accordingly, the optical axis of the incident light and the optical axis of the emitted light are configured to be parallel. In other words, as the image light diffracted by the first diffraction optical element 30a in the light incident side is reflected at the wave guide end portion of the second diffraction optical element 30b side, the image light can be diverted in a reverse direction to a light-guiding direction inside the light guide 20 right before the emission from the light guide 20, and the incident light with respect to the light incident surface 20a and the emitted light from the light emitting surface 20b can be parallel.

As a result, it is possible to more accurately match the positional relationship between the right/left light guides 20 and the image forming portion 10 to the shape of the face or the position of both of the eyes of the observer. In other words, as illustrated in FIG. 10, due to a size of the projection optical system, there is a possibility in which the image forming portion 10 comes into contact with the face of the observer and thereby an interruption occurring. According to the embodiment, as illustrated in FIG. 9, since the direction of contact with the face of the observer is avoided, the appearance can be obtained in which the fitting property with respect to the face is further improved.

Furthermore, in the embodiment, an arrangement interval (grating cycle) of the diffraction grating 30c in the first diffraction optical element 30a and an arrangement interval (grating cycle) of the diffraction grating 30d in the second diffraction optical element 30b are configured to be the same. By setting the grating cycles of the first diffraction optical element 30a and the second diffraction optical element 30b to be the same, it is possible to reduce an interference of the light between the two times of the diffraction by the incident side and the emitting side and a loss of a quantity of light, and to prevent deterioration of luminosity of the image or partial generation of color irregularity. Furthermore, in the embodiment, as grating patterns of the first diffraction optical element 30a and the second diffraction optical element 30b are the same, it is possible to set the optical axes of the incident light and the emitted light to be parallel, and to obtain high diffraction efficiency within a wide range of the angle of incidence.

As described above, according to the embodiment, first, regarding the incident angle with respect to the diffraction optical element, by setting the optical axis inclination to be large, it is possible to obtain the high diffraction efficiency within the wide range of the angle of incidence and to set the angle of view to be wide. As the diffraction optical element which transmits the image light reflected on the end surface of the light guide 20 and the light guide 20 are in the configuration, even when the optical axis inclined angle of the incident image light is large in order to obtain the large angle of view, without deteriorating the fitting property to the face of the observer, an image display apparatus, such as the head mount display, which is easy to be mounted and used, can be obtained.

### B: Second Embodiment

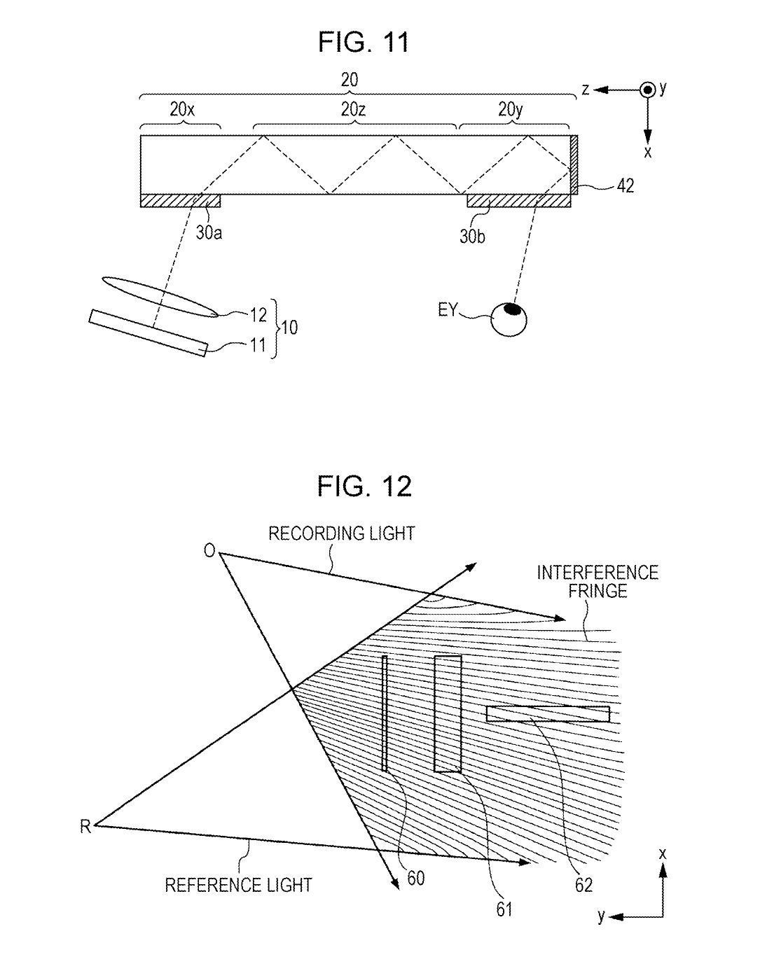

Next, the second embodiment of the invention will be described. In the embodiment, as the first diffraction optical element 30a and the second diffraction optical element 30b, a transmission type volume hologram is used. FIG. 11 is a cross-sectional view of the main part illustrating an example of the internal structure and the light guide of the optical system for the left eye in the embodiment. The description of the internal structure and the light guide of the optical system for the right eye is omitted, but the optical system for the right eye has a structure reversing right and left of the internal structure and the light guide of the optical system for the left eye.

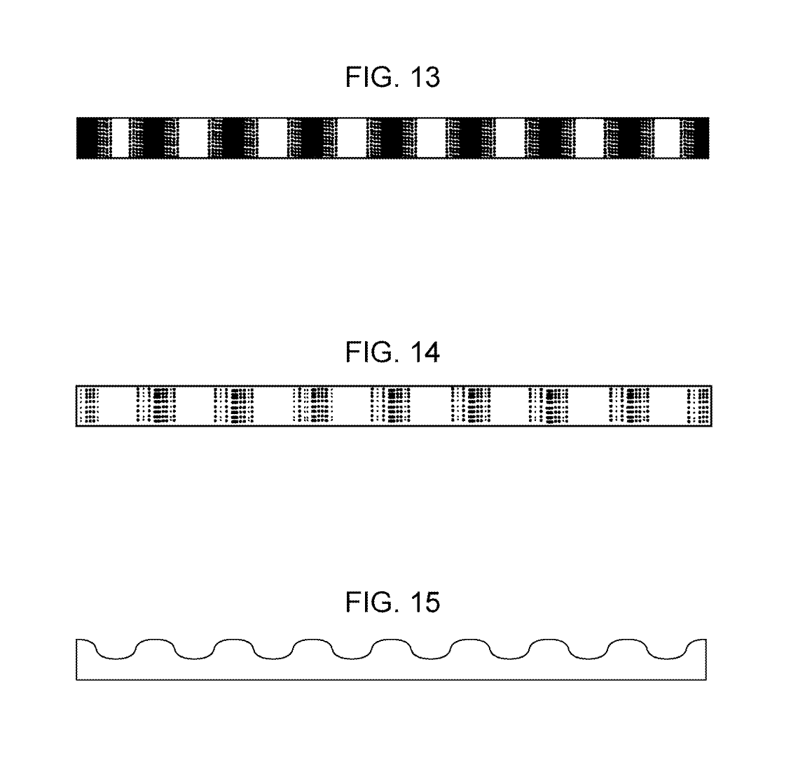

As described in FIG. 12, the transmission type volume hologram irradiates a surface (surface illustrated as a long edge in FIG. 12) of a sensitive material 61 with recording light and reference light, respectively, from different directions, and is formed by recording an interference fringe formed by the interference of the recording light and the reference light to the sensitive material 61. Among the transmission type volume hologram, a hologram which exposes the sensitive material including a silver salt emulsion, for example, and can be obtained by performing a developing and fixing process after exposing is an amplitude hologram. As illustrated in FIG. 13, in the amplitude hologram, intensity distribution of darkness of the interference fringe is recorded as a change of a black-and-white gradation. In addition, a hologram which is formed by using dichromated gelatin or photopolymer as the sensitive material is a phase hologram. As illustrated in FIG. 14, in the phase hologram, the interference fringe is recorded as a change of the refractive index. In addition, among the phase holograms, there are also holograms which use photoresist and thermoplastic as the sensitive material. In a case where the photoresist and the thermoplastic are used, as illustrated in FIG. 15, the interference fringe is recorded as unevenness of the surface.

In the embodiment, as the first diffraction optical element 30a and the second diffraction optical element 30b, the transmission type volume hologram is used. However, as an example, among the transmission type volume holograms, the phase hologram, which uses the polymer as the sensitive material and records the interference fringe as a change of the refractive index, is used. In FIG. 11, a portion which is drawn by an inclined line is the interference fringe, that is, the diffraction grating.

Even in the embodiment, the diffraction grating of the first diffraction optical element 30a is inclined so that the position on the contact surface with the light guide 20 is nearer to the center portion side of the light guide 20 rather than the position on the incident surface of the first diffraction optical element 30a. The diffraction grating of the second diffraction optical element 30b is inclined so that the position on the emitting surface of the second diffraction optical element 30b is nearer to the center portion side of the light guide 20 rather than the position on the contact surface with the light guide 20. The angle of inclination of the diffraction grating of the first diffraction optical element 30a and the angle of inclination of the diffraction grating of the second diffraction optical element 30b are set to be the same. In addition, even the grating cycles of the first diffraction optical element 30a and the second diffraction optical element 30b are the same.

In addition, as illustrated in FIG. 11, even in the embodiment, in the light guide 20 which uses the transmission type diffraction optical element, only the reflection layer 42 is disposed at the end portion of the wave guide of the second diffraction optical element 30b side inside the light guide 20, only the emitting side performs an end side reflection of the light guide 20, and another side does not perform the end surface reflection.

### Angle of Incidence Setting

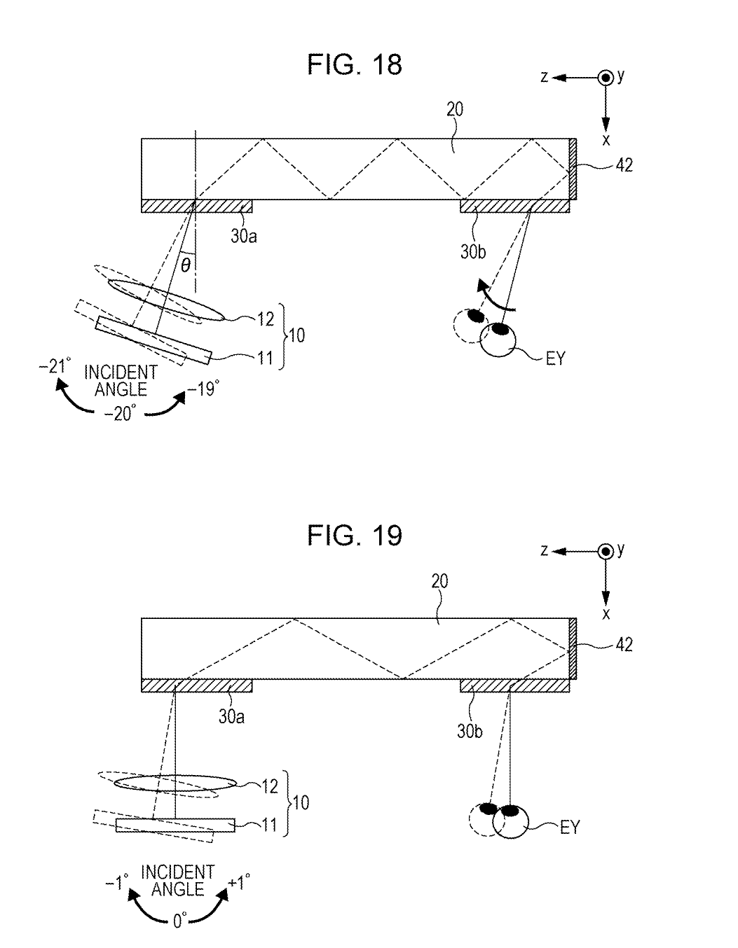

Next, an angle of incidence with respect to the diffraction optical element is described. In the embodiment, since the transmission type volume hologram is used as the diffraction optical element, the diffraction efficiency becomes greater by the incident angle of the luminous flux, and the diffraction efficiency at a certain incident angle (Bragg angle) is the maximum. Therefore, in order to improve the diffraction efficiency, as illustrated in FIGS. 18 and 19, the angle of incidence of the image light emitted from the image forming portion 10 is set to be a predetermined angle.

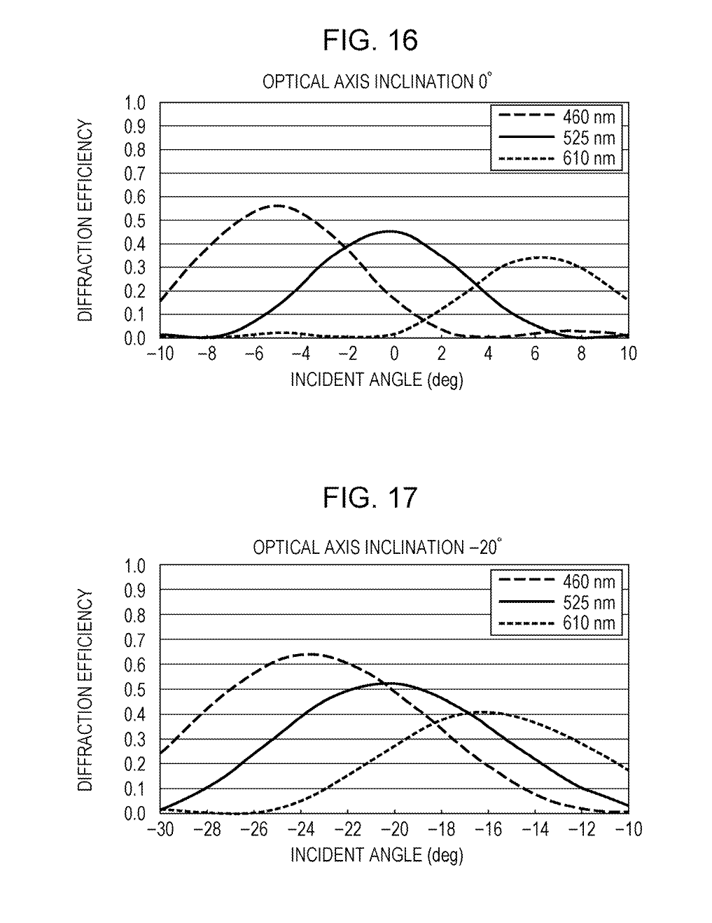

In FIGS. 16 and 17, in the transmission type volume hologram, an example of calculation of the incident angle and the diffraction efficiency of each RGB wavelength of a case where the optical axis of the incident light is inclined is illustrated. As illustrated in FIG. 19, in a case where the angle of incidence of the image light emitted from the image forming portion 10 is 0 degrees of the optical axis inclination (diffraction optical element which is optimized for orthogonal incidence), the maximum diffraction efficiency is low, as illustrated in FIG. 16, and the distribution range of the diffraction efficiency which is equal to or higher than the predetermined value is narrow. Meanwhile, as illustrated in FIG. 18, in a case where the angle of incidence of the image light emitted from the image forming portion 10 is −20 degrees of the optical axis inclination (diffraction optical element which is optimized for the incidence of the image light inclined by −20 degrees), the maximum diffraction efficiency is high as illustrated in FIG. 17, and the distribution of the diffraction efficiency which is equal to or higher than the predetermined value covers a wide range. As a result, when the optical axis inclination which has larger angle of incidence with respect to the diffraction optical element is adopted, the high diffraction efficiency can be obtained within the wide range of the angle of incidence, and the angle of view can be widened.

According to the embodiment, as the image light diffracted by the first diffraction optical element 30a in the light incident side is reflected at the end portion of the wave guide of the second diffraction optical element 30b side, the image light can be diverted in a reverse direction to a light-guiding direction inside the light guide 20 right before the emission from the light guide 20. Furthermore, the inclined angles of the diffraction gratings of the first diffraction optical element 30a and the second diffraction optical element 30b are set to be the same, and the grating cycles of the first diffraction optical element 30a and the second diffraction optical element 30b are set to be the same. Accordingly, the incident light on the light incident surface 20a and the emitted light from the light emitting surface 20b can be parallel, and it is possible to more accurately match the positional relationship between the right/left light guides and the image forming portion to the shape of the face or the position of both of the eyes of the observer. In other words, as illustrated in FIG. 10, due to the size of the projection optical system, there is a possibility in which the image forming portion 10 comes into contact with the face of the observer and thereby an interruption occurring. However, in the embodiment, as illustrated in FIG. 9, since the direction of contact with the face of the observer can be avoided, the appearance can be obtained in which the fitting property with respect to the face is further improved.

In addition, in the embodiment, by setting the grating cycles of the first diffraction optical element 30a and the second diffraction optical element 30b to be the same, it is possible to reduce the interference of the light between the two times of the diffraction by the incident side and the emitting side or the loss of the quantity of light, and to prevent deterioration of luminosity of the image or partial generation of color irregularity. Furthermore, in the embodiment, the first diffraction optical element 30a and the second diffraction optical element 30b are formed of the volume hologram, and the inclined angle and the grating cycle of the gratings of each volume hologram are the same. Accordingly, it is possible to set the optical axes of the incident light and the emitted light to be parallel, and to obtain the high diffraction efficiency within the wide range of the angle of incidence.

### C: Third Embodiment

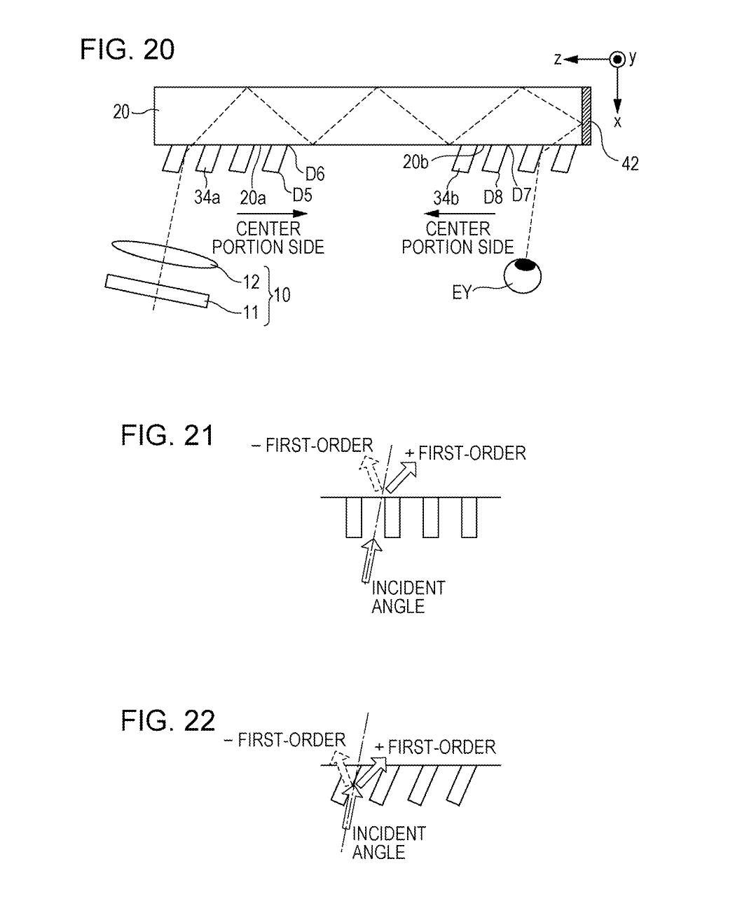

Next, the third embodiment of the invention will be described. In the embodiment, as the first diffraction optical element and the second diffraction optical element, a surface relief hologram is used. FIG. 20 is a cross-sectional view of the main part illustrating an example of the internal structure and the light guide of the optical system for the left eye in the embodiment. The description of the internal structure and the light guide of the optical system for the right eye is omitted, but the optical system for the right eye has a structure reversing right and left of the internal structure and the light guide of the optical system for the left eye.

As illustrated in FIG. 20, in the embodiment, an inclined surface relief hologram in which the surface of the surface relief hologram is inclined is used as a first diffraction optical element 34a and a second diffraction optical element 34b. The inclined surface of the inclined surface relief hologram of the first diffraction optical element 34a is inclined so that a position D6 on the surface side in contact with the light guide 20 of the first diffraction optical element 34a is nearer to the center portion side of the light guide 20 rather than a position D5 on a tip end of an incident side of the inclined surface. In addition, the inclined surface of the surface relief type hologram of the second diffraction optical element 34b is inclined so that a position D8 on a tip end of an emitting side of the inclined surface is nearer to the center portion side of the light guide 20 rather than a position D7 on the surface side in contact with the light guide 20 of the second diffraction optical element 34b. The angle of inclination of the inclined surface of the inclined surface relief hologram of the first diffraction optical element 34a and the angle of inclination of the inclined surface of the inclined surface relief hologram of the second diffraction optical element 34b are set to be the same. Furthermore, the grating cycles of the surface relief hologram of the first diffraction optical element 34a and the surface relief hologram of the second diffraction optical element 34b are the same.

When the diffracted light are arranged in order of zero-order, plus and minus first-order, . . . from the diffracted light which is close to the central axis of the incident light, as illustrated in FIG. 21, in a case of a rectangular-shaped surface relief hologram without the inclination, the intensity of plus first-order diffracted light and minus first-order diffracted light are substantially the same.

However, in a case of the inclined surface relief hologram in which the surface of the surface relief hologram is inclined, when the relationship between the inclination of the surface of the inclined surface relief hologram and the direction of the incident light is the relationship illustrated in FIG. 22, the diffracted light is generated by the Bragg reflection on the grating surface. For this reason, the intensity of the plus first-order diffracted light is higher than the intensity of the minus first-order diffracted light.

When a wavelength is λ, a thickness of the hologram is T, a refractive index of the hologram is n, and the grating cycle is d, characteristics of the hologram can be represented as the following parameter Q.

Q=2πλT/nd²

In a case where the parameter Q is Q<1, the hologram is referred to as a “thin hologram”, and in a case where the parameter Q is Q>10, the hologram is referred to as a “thick hologram”.

In a case of thick holograms 61 and 62 illustrated in FIG. 12, since several layers receive an operation of the Bragg grating, the Bragg condition is strict, and only the plus first-order diffracted light is generated. However, in a case of the inclined surface relief hologram of the embodiment, the hologram has characteristics of a boundary area between the thick holograms 61 and 62 and the thin hologram 60 illustrated in FIG. 12. As a result, weak minus first-order diffracted light is generated other than plus first-order diffracted light.

In this manner, in the embodiment, as the surface relief hologram is inclined, it is possible to further strengthen the plus first-order diffracted light, to improve transmission efficiency to the light guide 20, and to obtain an effect of reducing noise light. Furthermore, in the embodiment, not only the surface of the surface relief hologram of the first diffraction optical element 34a, but also the surface of the surface relief hologram of the second diffraction optical element 34b is inclined. Moreover, since the angles of inclination of the surfaces of the surface relief holograms of the first diffraction optical element 34a and the second diffraction optical element 34b are set to be the same, it is possible to set the incident light on the light incident surface 20a and the emitted light from the light emitting surface 20b to be parallel, and to more accurately match the positional relationship between the right/left light guides and the image forming portion and the shape of the face or the position of the both of the eyes of the observer. In other words, as illustrated in FIG. 10, due to the size of the projection optical system, there is a possibility in which the image forming portion 10 comes into contact with the face of the observer and thereby an interruption occurring. However, in the embodiment, as illustrated in FIG. 9, since the direction of contact with the face of the observer can be avoided, the appearance can be obtained in which the fitting property with respect to the face is further improved.

In addition, in the embodiment, by setting the grating cycles of the first diffraction optical element 34a and the second diffraction optical element 34b to be the same, it is possible to reduce the interference of the light between the two times of the diffraction by the incident side and the emitting side or the loss of the quantity of light, and to prevent deterioration of luminosity of the image or partial generation of color irregularity.

Furthermore, since the surface relief holograms of the first diffraction optical element 34a and the second diffraction optical element 34b are inclined in the same direction in the embodiment, it is advantageous that the holograms can be formed at the same time during die cutting, mass productivity can be improved, and manufacturing cost can be reduced.

### D: Fourth Embodiment

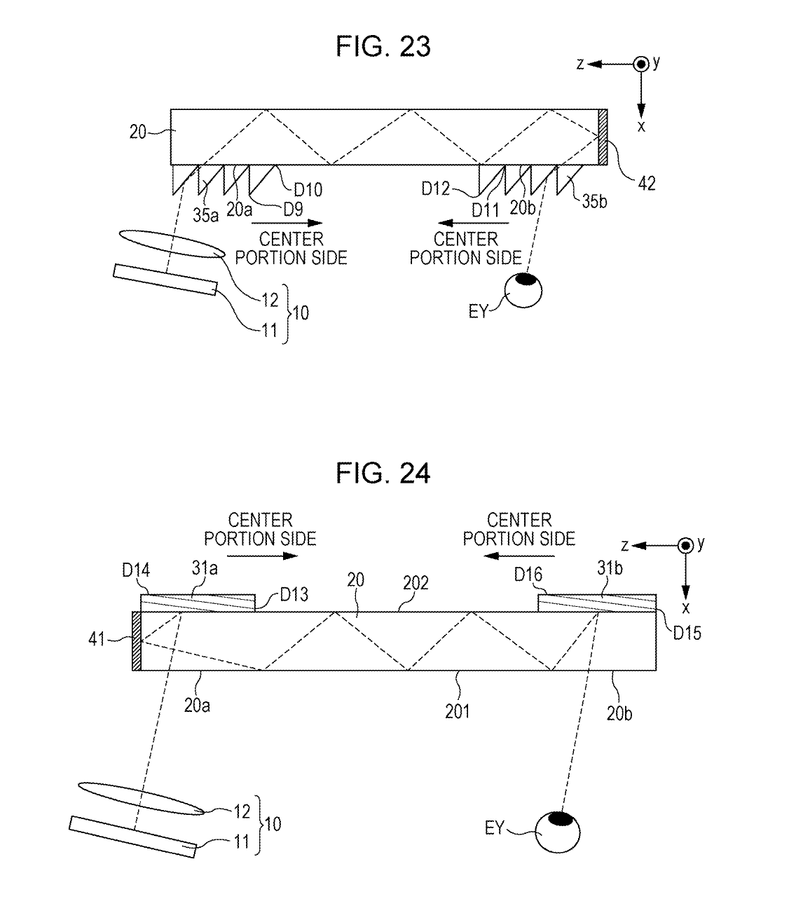

Next, a fourth embodiment of the invention will be described. In the embodiment, as the first diffraction optical element and the second diffraction optical element, a blazed grating is used. FIG. 23 is a cross-sectional view of the main part illustrating an example of the internal structure and the light guide of the optical system for the left eye in the embodiment. The description of the internal structure and the light guide of the optical system for the right eye is omitted, but the optical system for the right eye has a structure reversing right and left of the internal structure and the light guide of the optical system for the left eye.

As illustrated in FIG. 23, in the embodiment, the blazed grating is used as a first diffraction optical element 35a and a second diffraction optical element 35b. The inclined surface of the blazed grating of the first diffraction optical element 35a is inclined so that a position D10 on the surface side in contact with the light guide 20 of the first diffraction optical element 35a is nearer to the center portion side of the light guide 20 rather than a position D9 on a tip end of an incident side of the inclined surface. In addition, the inclined surface of the blazed grating of the second diffraction optical element is inclined so that a position D12 on a tip end of an emitting side of the inclined surface is nearer to the center portion side of the light guide 20 rather than a position D11 on the surface side in contact with the light guide 20 of the second diffraction optical element 35b. The angle of inclination of the inclined surface of the blazed grating of the first diffraction optical element 35a and the angle of inclination of the inclined surface of the blazed grating of the second diffraction optical element 35b are set to be the same. Furthermore, the grating cycles of the blazed grating of the first diffraction optical element 35a and the blazed grating of the second diffraction optical element 35b are the same.

Even when the blazed grating is used, when the relationship between the inclination of the inclined surface of the blazed grating and the direction of the incident light is the relationship illustrated in FIG. 23, the diffracted light is generated by the Bragg reflection on the grating surface. For this reason, the intensity of the plus first-order diffracted light is higher than the intensity of the minus first-order diffracted light.

In this manner, in the embodiment, by using the blazed grating, it is possible to further strengthen the plus first-order diffracted light, to improve the transmission efficiency to the light guide 20, and to obtain an effect of reducing the noise light. Furthermore, in the embodiment, not only the blazed grating of the first diffraction optical element 35a, but also the blazing grating of the second diffraction optical element 35b is used. However, since the angles of inclination of the inclined surfaces of the blazed grating of the first diffraction optical element 35a and the second diffraction optical element 35b are set to be the same, it is possible to set the incident light on the light incident surface 20a and the emitted light from the light emitting surface 20b to be parallel, and to more accurately match the positional relationship between the right/left light guides and the image forming portion to the shape of the face or the position of the both of the eyes of the observer. In other words, as illustrated in FIG. 10, due to the size of the projection optical system, there is a possibility in which the image forming portion 10 comes into contact with the face of the observer and thereby an interruption occurring. However, in the embodiment, as illustrated in FIG. 9, since the direction of contact with the face of the observer can be avoided, the appearance can be obtained in which the fitting property with respect to the face is further improved.

In addition, in the embodiment, by setting the grating cycles of the first diffraction optical element 35a and the second diffraction optical element 35b to be the same, it is possible to reduce the interference of the light between the two times of the diffraction by the incident side and the emitting side or the loss of the quantity of light, and to prevent deterioration of luminosity of the image or partial generation of color irregularity.

Furthermore, since the inclined surface of the blazed grating of the first diffraction optical element 35a and the second diffraction optical element 35b are inclined in the same direction in the embodiment, it is advantageous that the blazed grating can be formed at the same time during die cutting, mass productivity can be improved, and manufacturing cost can be reduced.

### E: Fifth Embodiment

Next, a fifth embodiment of the invention will be described. In the embodiment, as the first diffraction optical element and the second diffraction optical element, a reflection type volume hologram is used. FIG. 24 is a cross-sectional view of the main part illustrating an example of the internal structure and the light guide of the optical system for the left eye in the embodiment. The description of the internal structure and the light guide of the optical system for the right eye is omitted, but the optical system for the right eye has a structure reversing right and left of the internal structure and the light guide of the optical system for the left eye.

A thick hologram 61 illustrated in FIG. 12 is the transmission type volume hologram, and the thick hologram 62 is a reflection type volume hologram. As illustrated in FIG. 12, in a case of the transmission type volume hologram, an interference fringe is formed by irradiating the surface (portion illustrated as a long edge in FIG. 12) of the sensitive material with recording light and reference light, respectively, in different directions. However, in a case of the reflection type volume hologram illustrated as the thick hologram 62, the interference fringe is formed by irradiating an upper surface (upward portion in an x-axis direction among the portions illustrated as a long edge in FIG. 12) of the sensitive material with the recording light, and by irradiating a lower surface (downward portion in the x-axis direction among the portions illustrated as a long edge in FIG. 12) of the sensitive material with the reference light.

In FIG. 12, when the transmission type volume hologram illustrated as the thick hologram 61 is rotated leftward by 90 degrees, and when the surface (portion which is illustrated as a long edge in FIG. 12 and irradiated with the recording light and the reference light) of the transmission type volume hologram moves downward in the x-axis direction, it is known that a slant of the interference fringe, that is, a slant of the diffraction grating in the transmission type volume hologram and in the reflection type volume hologram is reversed. In other words, in a state where the transmission type volume hologram is rotated leftward by 90 degrees, when the diffraction gratings are lines on an xy coordinate plane in FIG. 12, the line segment is a line segment which has a positive slant. However, if the diffraction grating of the reflection type volume hologram is the lines on the xy coordinate plane in FIG. 12, the line segment is a line segment which has a negative slant.

In addition, the slant of the diffraction grating of the reflection type volume hologram is smaller than the slant of the diffraction grating of the transmission type volume hologram. In some cases, an upper surface and a lower surface of the reflection type volume hologram are substantially parallel. In the embodiment, the reflection type volume hologram illustrated in FIG. 24 is used as the first diffraction optical element 31a and the second diffraction optical element 31b.

As illustrated in FIG. 24, the first diffraction optical element 31a is provided at a position facing the light incident surface 20a of the second panel surface 202 side, diffracts the light incident from the light incident surface 20a by the first diffraction optical element 31a in a predetermined direction, and reflects the light to the inside of the light guide 20. In addition, the second diffraction optical element 31b is provided at a position facing the light emitting surface 20b of the second panel surface 202 side, diffracts and reflects the image light guided inside the light guide 20 by the second diffraction optical element 31b to the light emitting surface 20b, and emits the light to the outside of the light guide 20 from the light emitting surface 20b.

The inclined surface of the diffraction grating of the first diffraction optical element 31a is inclined so that a position D13 on the surface side in contact with the light guide 20 of the first diffraction optical element 31a is nearer to the center portion side of the light guide 20 rather than a position D14 on a surface side facing the contact surface. In addition, the inclined surface of the diffraction grating of the second diffraction optical element 31b is inclined so that a position D16 on the surface side facing the contact surface is nearer to the center portion side of the light guide 20 rather than a position D15 on the surface side in contact with the light guide 20 of the second diffraction optical element 31b. The angle of inclination of the diffraction grating of the first diffraction optical element 31a and the angle of inclination of the diffraction grating of the second diffraction optical element 31b are set to be the same. Furthermore, the grating cycle of the diffraction grating of the first diffraction optical element 31a and the grating cycle of the diffraction grating of the second diffraction optical element 31b are the same.

Inside the light guide 20, a reflection layer 41 is disposed in the wave guide of the image light. In the embodiment, the reflection layer 41 is disposed at the end portion of the wave guide of the first diffraction optical element 31a side inside the light guide 20. In the light guide 20 using the reflection type diffraction optical elements 31a and 31b, only the incident side performs an end surface reflection of the light guide 20, and another side does not perform the end surface reflection.

In the embodiment, since the directions of the inclination of the diffraction gratings of each volume hologram of the first diffraction optical element 31a and the second diffraction optical element 31b are set to be the same, and since the grating cycles are set to be the same, even in a configuration in which the reflection layer 41 is disposed only at an end portion of the wave guide of the first diffraction optical element 31a side, the optical axis of the incident light and the optical axis of the emitted light can be parallel.

According to the embodiment, immediately after reflecting and diffracting the image light incident on the light guide 20 in a direction which is reverse to the light guide direction inside the light guide 20 by the first diffraction optical element 31a, the image light is further diverted to the light guide direction by the reflection layer 41. The image light is reflected and diffracted by the second diffraction optical element 31b, and emitted toward the eye EY of the observer from the light emitting surface 20b. Accordingly, the incident light on the light incident surface 20a and the emitted light from the light emitting surface 20b can be parallel, and it is possible to more accurately match the positional relationship between the right/left light guides 20 and the image forming portion 10 to the shape of the face or the position of the both of the eyes of the observer. In other words, as illustrated in FIG. 10, due to the size of the projection optical system, there is a possibility in which the image forming portion 10 comes into contact with the face of the observer and thereby an interruption occurring. However, in the embodiment, as illustrated in FIG. 9, since the direction of contact with the face of the observer can be avoided, the appearance can be obtained in which the fitting property with respect to the face is further improved.

In addition, in the embodiment, by setting the grating cycles of the first diffraction optical element 31a and the second diffraction optical element 31b to be the same, it is possible to reduce the interference of the light between the two times of the diffraction by the incident side and the emitting side or the loss of the quantity of light, and to prevent deterioration of luminosity of the image or partial generation of color irregularity. Furthermore, in the embodiment, the first diffraction optical element 31a and the second diffraction optical element 31b are formed by the volume hologram, and the grating patterns of each volume hologram are the same. Accordingly, it is possible to set the optical axes of the incident light and the emitted light to be the same, and to obtain the high diffraction efficiency within the wide range of the angle of incidence.

### F: Modification Example

### Modification Example 1

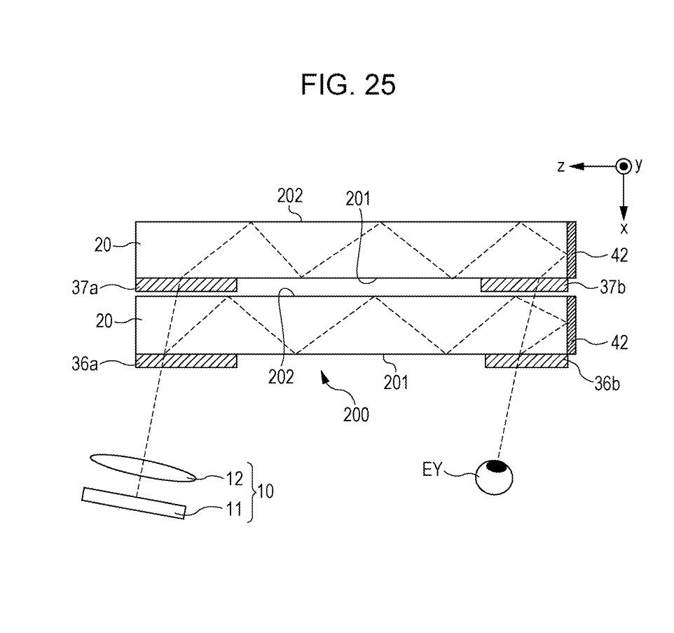

In the above-described first to fifth embodiments, one diffraction optical element is respectively used on the incident side and on the emitting side, while using a one-layered light guide. However, the invention is not limited thereto, and a plurality of diffraction optical elements corresponding to the wavelength of the image light may be used. In other words, as illustrated in FIG. 25, in each of the above-described embodiments, while the light guide 20 is stacked to be parallel with panel surfaces 201 and 202 and a stack type light guide 200 is formed, the grating cycles of the first diffraction optical elements 36a, 37a, . . . provided with relative light guides 20 and 20, and the second diffraction optical elements 36b, 37b, . . . are different for each light guide.

According to the modification example, the plurality of light guides 20 is stacked, and each light guide 20 uses diffraction optical elements which have different grating cycles. Accordingly, it is possible to transmit a different wavelength for each light guide, and to enhance the diffraction efficiency with respect to the plurality of wavelengths.

### Modification Example 2

In the above-described first to fifth embodiments and the modification example 1, the volume hologram is used as the diffraction optical element, but the invention is not limited thereto. Various diffraction optical elements can be used.

The entire disclosure of Japanese Patent Application No. 2013-179161, filed Aug. 30, 2013 is expressly incorporated by reference herein.

What is claimed is:

1. An optical device, comprising:
a light guide;
a first diffraction optical element which makes light incident on the light guide;
a second diffraction optical element which emits the light from the light guide; and
a reflection layer provided on a second surface of the light guide which intersects with a first surface of the light guide provided with the first diffraction optical element or the second diffraction optical element,
wherein protruded portions which respectively constitute the first diffraction optical element and the second optical element are respectively inclined in a first direction which is the same as a normal line direction of the first surface.

2. The optical device according to claim 1,
wherein the first diffraction optical element and the second diffraction optical element are respectively surface relief type holograms provided with an uneven structure on one surface.

3. The optical device according to claim 1,
wherein the first diffraction optical element and the second diffraction optical element are respectively diffraction optical elements in a shape of a blazed grating provided with protruded portions in a serrated shape on one surface.

4. An optical device, comprising:
a light guide;
a first diffraction optical element which makes light incident on the light guide;
a second diffraction optical element which emits the light from the light guide; and
a reflection layer provided on a second surface of the light guide which intersects with a first surface of the light guide provided with the first diffraction optical element and the second diffraction optical element,
wherein a first portion and a second portion which respectively constitute the first diffraction optical element and the second diffraction optical element and have different refractive indexes from each other, are respectively inclined in the first direction which is the same as the normal line direction of the first surface.

5. The optical device according to claim 4,
wherein the first diffraction optical element and the second diffraction optical element are transmission type volume holograms.

6. The optical device according to claim 1,
wherein the first diffraction optical element and the second diffraction optical element are transmission type diffraction optical elements, and are provided on the same surface of the light guide, and
wherein, in a cross-sectional view of the light guide including both the first diffraction optical element and the second diffraction optical element, the first direction is a direction which is inclined in a direction from the second diffraction optical element toward the first diffraction optical element with respect to the normal line direction of the first surface.

7. An optical device, comprising:
a light guide;
a first diffraction optical element which diffracts light incident on the light guide;
a second diffraction optical element which diffracts and emits the light guided from the light guide; and
a reflection layer provided on a second surface of the light guide which intersects with a first surface of the light guide provided with the first diffraction optical element or the second diffraction optical element,
wherein a first portion and a second portion which respectively constitute the first diffraction optical element and the second diffraction optical element and have different refractive indexes from each other, are respectively inclined in the first direction which is the same as the normal line direction of the first surface.

8. The optical device according to claim 7,
wherein the first diffraction optical element and the second diffraction optical element are reflection type diffraction optical elements, and are provided on the same surface of the light guide, and
wherein, in a cross-sectional view of the light guide including both the first diffraction optical element and the second diffraction optical element, the first direction is a direction which is inclined in a direction from the second diffraction optical element toward the first diffraction optical element with respect to the normal line direction of the first surface.

9. An optical device, comprising:
a first light guide;
a first diffraction optical element which makes light incident on the first light guide;
a second diffraction optical element which emits the light from the first light guide;
a first reflection layer provided on a second surface of the light guide which intersects with a first surface of the light guide provided with the first diffraction optical element or the second diffraction optical element;
a second light guide;
a third diffraction optical element which makes light incident on the second light guide;
a fourth diffraction optical element which emits the light from the second light guide; and
a second reflection layer provided on a fourth surface of the light guide which intersects with a third surface of the light guide provided with the third diffraction optical element or the fourth diffraction optical element,
wherein protruded portions which constitute the first diffraction optical element and the second optical element are respectively inclined in a first direction which is the same as a normal line direction of the first surface, and
wherein protruded portions which constitute the third diffraction optical element and the fourth optical element are respectively inclined in a second direction which is the same as the normal line direction of the third surface.

10. An optical device, comprising:
a first light guide;
a first diffraction optical element which makes light incident on the first light guide;
a second diffraction optical element which emits the light from the first light guide;
a first reflection layer provided on a second surface of the light guide which intersects with a first surface of the light guide provided with the first diffraction optical element or the second diffraction optical element;
a second light guide;
a third diffraction optical element which makes light incident on the second light guide;
a fourth diffraction optical element which emits the light from the second light guide; and
a second reflection layer provided on a fourth surface of the light guide which intersects with a third surface of the light guide provided with the third diffraction optical element or the fourth diffraction optical element,
wherein a first portion and a second portion which respectively constitute the first diffraction optical element and the second diffraction optical element and have different refractive indexes from each other, are inclined in a first direction which is the same as a normal line direction of the first surface, respectively, and
wherein a third portion and a fourth portion which respectively constitute the third diffraction optical element and the fourth diffraction optical element and have different refractive indexes from each other, are respectively inclined in a second direction which is the same as the normal line direction of the third surface.

11. An optical device, comprising:
a first light guide;
a first diffraction optical element which diffracts light incident on the first light guide;
a second diffraction optical element which diffracts and emits the light guided from the first light guide;
a first reflection layer provided on a second surface of the light guide which intersects with a first surface of the light guide provided with the first diffraction optical element or the second diffraction optical element;
a second light guide;
a third diffraction optical element which diffracts light incident on the second light guide;
a fourth diffraction optical element which diffracts and emits the light from the second light guide; and
a second reflection layer provided on a fourth surface of the light guide which intersects with a third surface of the light guide provided with the second diffraction optical element or the third diffraction optical element,
wherein a first portion and a second portion which respectively constitute the first diffraction optical element and the second diffraction optical element and have different refractive indexes from each other, are inclined in a first direction which is the same as a normal line direction of the first surface, respectively, and
wherein a third portion and a fourth portion which respectively constitute the third diffraction optical element and the fourth diffraction optical element and have different refractive indexes from each other, are respectively inclined in a second direction which is the same as the normal line direction of the third surface.

12. An image display apparatus, comprising:
an optical device according to claim 1; and
an image forming portion which generates the image light.

13. An image display apparatus, comprising:
an optical device according to claim 4; and
an image forming portion which generates the image light.

14. An image display apparatus, comprising:
an optical device according to claim 7; and
an image forming portion which generates the image light.

15. An image display apparatus, comprising:
an optical device according to claim 9; and
an image forming portion which generates the image light.

16. An image display apparatus, comprising:
an optical device according to claim 10; and
an image forming portion which generates the image light.

17. An image display apparatus, comprising:
an optical device according to claim 11; and
an image forming portion which generates the image light.
